(19) United States
(12) Patent Application Publication
(10) Pub. No.: US 2009/0183376 A1
(43) Pub. Date: Jul. 23, 2009

(54) MANUAL CLIPPER ASSEMBLY

(76) Inventor: Hou-Pia WANG, Chang-Hua City (TW)

Correspondence Address: Brinks Hofer Gilson & Lione/Ann Arbor, 524 South Main Street, Suite 200, Ann Arbor, MI, 48104, US

(21) Appl. No.: 12/119,977

(22) Filed: May 13, 2008

(30) Foreign Application Priority Data
Jan. 22, 2008 (TW) 097201376

(51) Int. Cl. B26B 13/00

(52) U.S. Cl. 30/233.5

(57) ABSTRACT

A manual clipper assembly includes a handle unit, and a clipper blade having a plate member, a comb portion, and a plurality of blades. The handle unit includes an elongated handle, and a mounting seat disposed on one end of the handle. The plate member has a geometric center, and defines a first line and a second line. The plate member has a pair of lateral edges, a rear edge, and a front edge. The front edge is curved inwardly toward the first line such that a center portion of the front edge is closer to the first line than opposite ends of the front edge. The comb portion is disposed on the front edge, and includes a plurality of spaced-apart teeth. Adjacent pairs of the teeth respectively define grooves therebetween. The blades extend from the front edge respectively in the grooves.

### CROSS-REFERENCE TO RELATED APPLICATION

This application claims priority of Taiwanese application no. 097201376, filed on Jan. 22, 2008.

### BACKGROUND OF THE INVENTION

1. Field of the Invention

This invention relates to a manual clipper assembly, more particularly to a manual clipper assembly with a curved clipper blade for trimming hair growing from curved body surfaces.

2. Description of the Related Art

Referring to FIG. 1, a conventional shaving device 1 is used to brush and trim pet hair. The shaving device 1 includes a handle 11, a flat comb member 12 disposed at one end of the handle 11, a blade 13 mounted to the flat comb member 12, and a cover 14 for securing the blade 13 onto the flat comb member 12.

The flat comb member 12 includes two rows of teeth 121 formed respectively on opposite sides of the flat comb member 12. Each tooth 121 has a tip portion 122 and a base portion 123. Each row of the teeth 121 is arranged in a straight line.

The blade 13 includes opposite straight blade edges 131. Each straight blade edge 131 is disposed between the tip portions 122 and the base portions 123 of a corresponding row of the teeth 121.

Referring to FIG. 2, while the two rows of teeth 121 and the blade edges 13.1 are respectively formed in a straight line as described above, the bodies of most pets are curved. Therefore, a disadvantage of the conventional shaving device 1 is that non-uniform trimming may occur, resulting in a coat for the pet that is unevenly cut. Another disadvantage is that only a small trim area is achieved for each stroke of the shaving device 1. As a consequence, the trimming operation must be repeated multiple times in each area.

### SUMMARY OF THE INVENTION

It is an object of the present invention to provide a manual clipper assembly that can overcome the above drawbacks of the prior art.

According to the present invention, a manual clipper assembly includes a handle unit, and a clipper blade having a plate member, a comb portion, and a plurality of blades. The handle unit includes an elongated handle, and a mounting seat disposed on one end of the handle. The clipper blade is mounted on the mounting seat of the handle unit.

The plate member has a geometric center, and defines a first line and a second line passing through the geometric center and that are perpendicular to each other. The plate member has a pair of lateral edges spaced apart from each other along the direction of the first line, a rear edge interconnecting the lateral edges and disposed at one side of the first line, and a front edge interconnecting the lateral edges and disposed at the other side of the first line. The front edge is curved inwardly toward the first line such that a center portion of the front edge is closer to the first line than opposite ends of the front edge.

The comb portion is disposed on the front edge of the plate member, and includes a plurality of spaced-apart teeth of substantially equal length and extending from the front edge of the plate member away from the first line away from the first line. Adjacent pairs of the teeth respectively define grooves therebetween.

The blades extend from the front edge of the plate member away from the first line respectively in the grooves.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional shaving device;

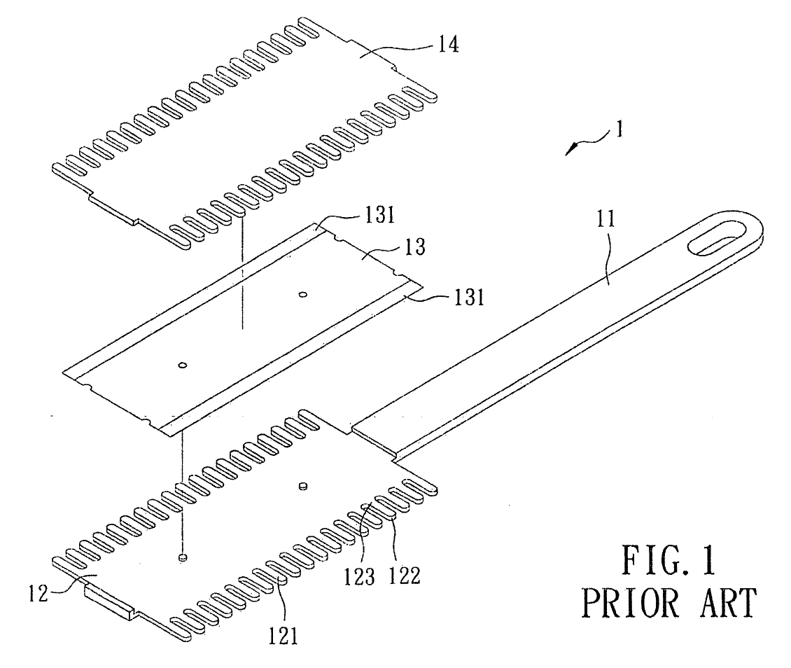

FIG. 2 shows the shaving device of FIG. 1 in a state of use;

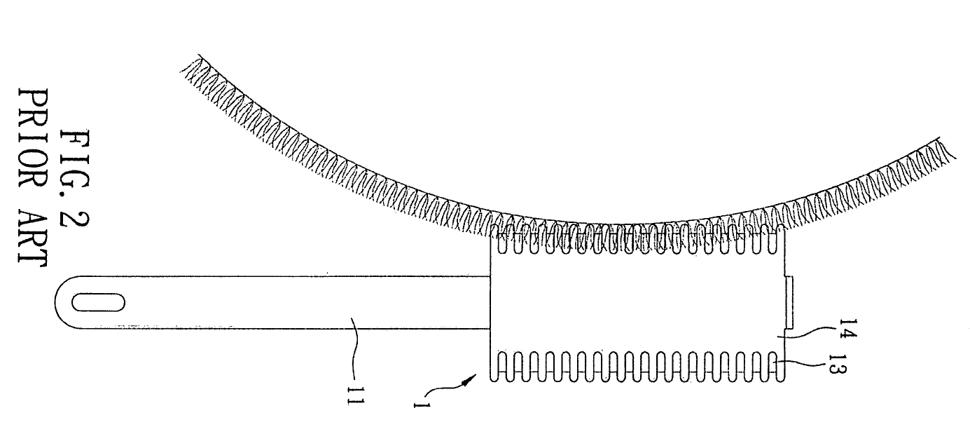

FIG. 3 is a perspective view of the preferred embodiment of a manual clipper blade according to the present invention;

FIG. 4 shows a front view of FIG. 3;

FIG. 5 is a sectional view of the manual clipper blade taken along the line V-V of FIG. 4;

FIG. 6 shows the manual clipper blade of the preferred embodiment in a state of use;

FIG. 7 is a perspective view of a modified example of the preferred embodiment of the manual clipper blade according to the present invention;

FIG. 8 is an exploded perspective of the preferred embodiment of a manual clipper assembly according to the present invention; and

FIG. 9 is a partly sectional side view of the manual clipper assembly shown in FIG. 8.

### DETAILED DESCRIPTION OF THE PREFERRED EMBODIMENTS

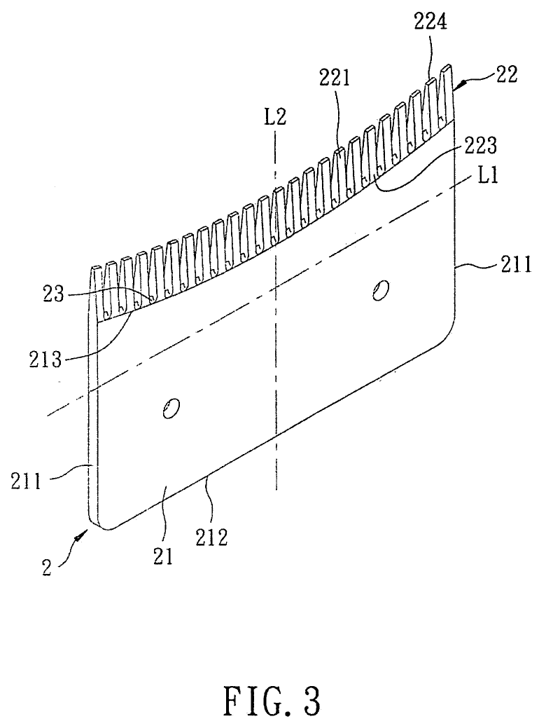

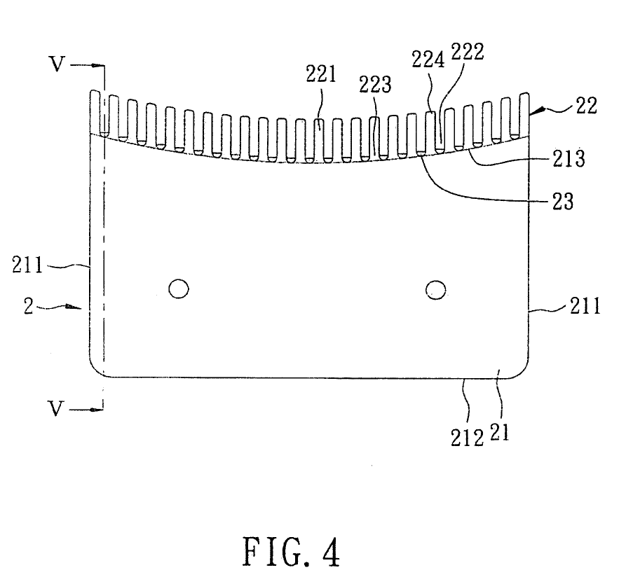

Referring to FIGS. 3, 4, 8, and 9, the preferred embodiment of a manual clipper assembly according to this invention includes a handle unit 3, and a clipper blade 2 having a flat plate member 21, a comb portion 22, and a plurality of blades 23. The clipper blade 2 is small, lightweight, made of a metal material, and suitable for use on small animals, such as guinea pigs, small dogs and cats, etc. The handle unit 3 includes an elongated handle 31, and a mounting seat 32 disposed on one end of the handle 31. The clipper blade 2 is mounted on the mounting seat 32 of the handle unit 3.

The plate member 21 of the clipper blade 2 has a geometric center, and defines a first line L1 and a second line L2 (see FIG. 3) passing through the geometric center and that are perpendicular to each other. The plate member 21 has a pair of lateral edges 211 spaced apart from each other along the direction of the first line L1, a rear edge 212 interconnecting the lateral edges 211 and disposed at one side of the first line L1, and a front edge 213 interconnecting the lateral edges 211 and disposed at the other side of the first line L1. The front edge 213 is curved inwardly toward the first line L1 such that a center portion of the front edge 213 is closer to the first line L1 than opposite ends of the front edge 213. In the preferred embodiment, the front edge 213 is symmetrical relative to the second line L2 and a center point thereof is closest to the first line L1 while opposite ends of the front edge 213 are farthest from the first line L1. However, in some embodiments, the front edge 213 may be outwardly curved in such a manner that the ends of the front edge 213 are closest to the first line L1.

The comb portion 22 of the clipper blade 2 is disposed on the front edge 213 of the plate member 21, and includes a plurality of spaced-apart teeth 221 of substantially equal length and that extend from the front edge 213 of the plate member 21 away from the first line L1. Each tooth 221 includes a base portion 223 and a tip portion 224. Adjacent pairs of the teeth 221 respectively define grooves 222 therebetween.

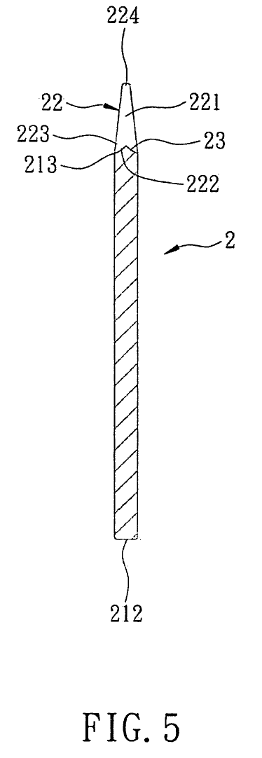

With further reference to FIG. 5, the blades 23 of the clipper blade 2 extend from the front edge 213 of the plate member 21 away from the first line L1 respectively in the grooves 224. In the preferred embodiment, a cross section of each of the blades 23 extends in a direction parallel to the second line L2 and is tapered. Such a configuration allows the blades 23 to cut hair in both directions. That is, regardless of which direction pet hair is passed through the grooves 224, the blades 23 are able to cut the hair.

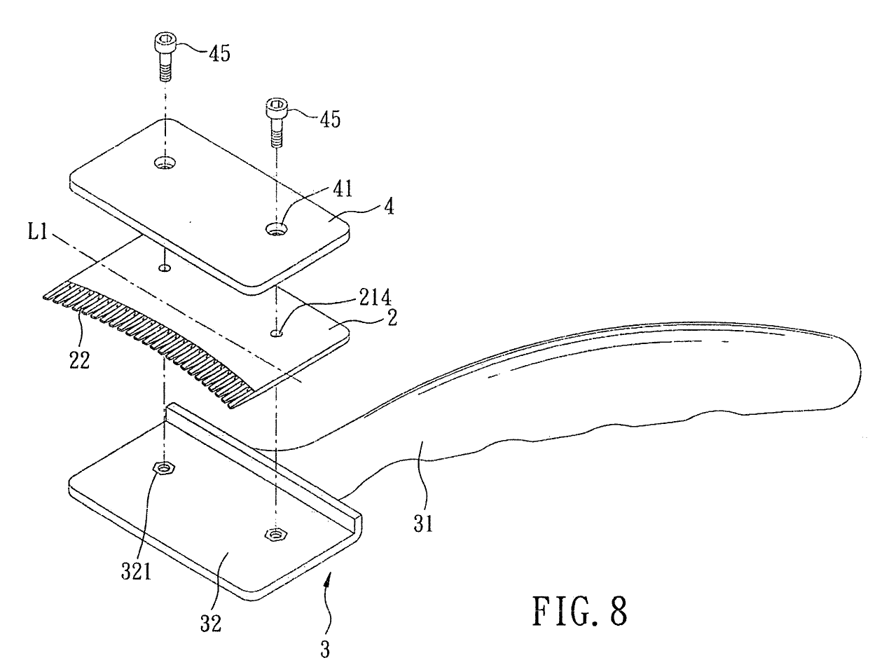

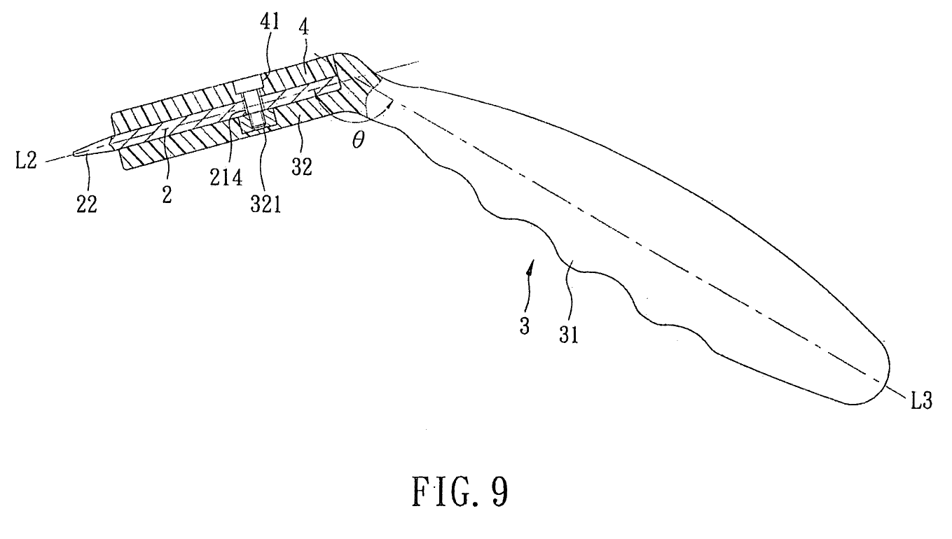

Reference is now made to FIGS. 8 and 9. The manual clipper assembly further comprises a cover 4 detachably mounted to the mounting seat 32 of the handle unit 3. The cover 4 and the mounting seat 32 interpose the clipper blade 2 therebetween. The mounting seat 32 is formed with a pair of threaded apertures 321 in the preferred embodiment. However, in some embodiments, the mounting seat 32 may be formed with only one threaded aperture 321 or more than two threaded apertures 321. The cover 4 has two first through-holes 41 corresponding in location to the two threaded apertures 321. The clipper blade 2 has two second through-holes 214 corresponding in location to the pair of threaded apertures 321. The number of the first and second through-holes 41, 214 may be varied so as to correspond to the number of the threaded apertures 321.

To assemble the manual clipper assembly, the first through-holes 41 of the cover 4 and the second through-holes 214 of the clipper blade 2 are aligned with the threaded apertures 321 of the mounting seat 32, after which the cover 4 and the clipper blade 2 are secured to the mounting seat 32 via a pair of fasteners 45. In some embodiments, the threaded apertures 321 of the mounting seat 32 may be replaced by two protrusions (not shown) that are insertable respectively into the second through-holes 214 of the clipper blade 2.

As illustrated in FIGS. 3 and 5, the thickness of the base portions 223 of the teeth 221 in a direction perpendicular to the first and second lines L1, L2 is substantially equal to that at the front edge 213 of the plate member 21. The opposite lateral sides of the teeth 221 are formed with smooth surfaces and are tapered in a direction away from the front edge 213 of the plate member 21 (i.e., the tip portion 224 of each tooth 221 has a thickness less than that of the base portion 223 thereof). Hence, pet hair may be easily combed, with the teeth 221 of the comb portion 22 effortlessly and deeply slipping into the coat of a pet.

Referring to FIG. 9, the handle 31 defines a third line L3 that extends along a longitudinal axis of the handle 31. The third line L3 forms substantially an obtuse angle (θ) with the second line L2 of the plate member 21, and a right angle with the first line L1 of the plate member 21 of the clipper blade 2. Such an angular relationship between the handle 31 and the clipper blade 2 allows for optimal handling of the manual clipper assembly.

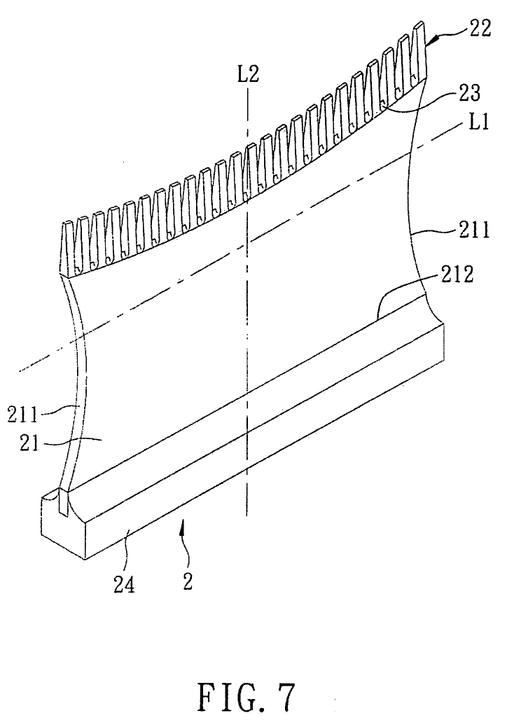

Referring to FIG. 7, in a modified example of the preferred embodiment, the clipper blade 2 may further comprise a grip portion 24 that is mounted on the rear edge 212 of the plate member 21, and that has a thickness greater than the thickness of the plate member 21. In this modified example of the preferred embodiment, the lateral edges 211 of the plate member 21 may be indented towards the second line L2.

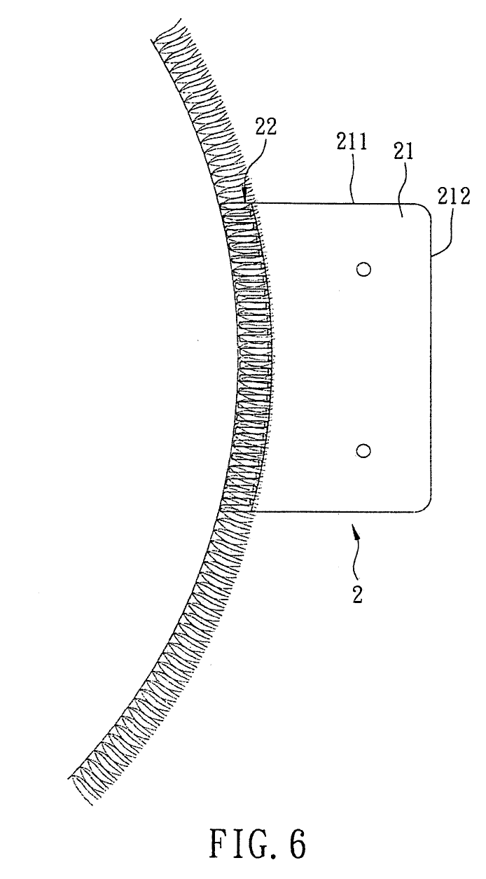

The modified example of the preferred embodiment allows the clipper blade 2 to be more easily used as a stand-alone device without requiring the use of the handle unit 3. In the modified example of the preferred embodiment, the grip portion 24 and even the lateral edges 211 may be held by the user when trimming pet hair. However, it is noted that the clipper blade 2 of FIG. 3 without the grip portion 24 and/or the inwardly indented lateral edges 211 may also be used as a stand-alone device without requiring the handle unit 3, as shown in FIG. 6.

The manual clipper assembly of FIG. 8, the clipper blade 2 of FIG. 3, and the clipper blade 2 of FIG. 7 of the present invention are advantageous in that the teeth 221 and the blades 23 are curvedly arranged with respect to the first line L1. Due to such a configuration, the teeth 221 and the blades 23 can conform to the curved surfaces of a pet's body as shown, for example, in FIG. 6. Therefore, uniform trimming can be realized, and a wider cutting area may be achieved so that repetitive trimming of the same area is unnecessary.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A manual clipper blade comprising:
a plate member having a geometric center, and defining first and second lines passing through said geometric center and perpendicular to each other, said plate member having a pair of lateral edges spaced apart from each other along the direction of said first line, a rear edge interconnecting said lateral edges and disposed at one side of said first line, and a front edge interconnecting said lateral edges and disposed at the other side of said first line, said front edge being curved inwardly toward said first line such that a center portion of said front edge is closer to said first line than opposite ends of said front edge;
a comb portion disposed on said front edge of said plate member, and including a plurality of spaced-apart teeth of substantially equal length and extending from said front edge of said plate member away from said first line, adjacent pairs of said teeth respectively defining grooves therebetween; and
a plurality of blades extending from said front edge of said plate member away from said first line respectively in said grooves.

2. The manual clipper blade of claim 1, wherein each of said teeth of said comb portion is tapered in a direction away from said front edge of said plate member.

3. The manual clipper blade of claim 1, further comprising a grip portion mounted on said rear edge of said plate member, and having a thickness that is greater than a thickness of said plate member.

4. A manual clipper assembly comprising:
a handle unit including an elongated handle, and a mounting seat disposed on one end of said handle; and
a clipper blade mounted on said mounting seat of said handle unit and including
a plate member having a geometric center, and defining a first line and a second line passing through said geometric center and perpendicular to each other, said plate member having a pair of lateral edges spaced apart from each other along the direction of said first line, a rear edge interconnecting said lateral edges and disposed at one side of said first line, and a front edge interconnecting said lateral edges and disposed at the other side of said first line, said front edge being curved inwardly toward said first line such that a center portion of said front edge is closer to said first line than opposite ends of said front edge,
a comb portion disposed on said front edge of said plate member, and including a plurality of spaced-apart teeth of substantially equal length and extending from said front edge of said plate member away from said first line, adjacent pairs of said teeth respectively defining grooves therebetween, and
a plurality of blades extending from said front edge of said plate member away from said first line respectively in said grooves.

5. The manual clipper assembly of claim 4, wherein said handle defines a third line that extends along a longitudinal axis of said handle, said third line forming substantially a right angle with said first line of said plate member of said clipper blade.

6. The manual clipper assembly of claim 4, wherein said handle defines a third line that extends along a longitudinal axis of said handle, said third line forming substantially an obtuse angle with said second line of said plate member of said clipper blade.

7. The manual clipper assembly of claim 4, wherein each of said teeth of said comb portion is tapered in a direction away from said front edge of said plate member.

8. The manual clipper assembly of claim 4, further comprising a cover detachably mounted to said mounting seat of said handle unit, said cover and said mounting seat interposing said clipper blade therebetween.
